(19) United States
(12) Patent Application Publication
(10) Pub. No.: US 2026/0242236 A1
(43) Pub. Date: Aug. 20, 2026

(54) HYDROXIDE DERIVED 1D NANOMATERIAL-BASED FIBER NETWORKS

(71) Applicant: DREXEL UNIVERSITY, Philadelphia, PA (US)

(72) Inventors: Gregory R. SCHWENK, Philadelphia, PA (US); Michel W. BARSOUM, Moorestown, NJ (US)

(21) Appl. No.: 19/159,712

(22) PCT Filed: Feb. 28, 2024
(86) PCT No.: PCT/US2024/017696

§ 371 Date: Aug. 26, 2025

Related U.S. Application Data
(60) Provisional application No. 63/487,319, filed on Feb. 28, 2023.

(51) Int. Cl. C01G 23/047; C01B 35/04; D04H 1/4209

(52) U.S. Cl. CPC C01G 23/047; C01B 35/04; D04H 1/4209; C01P 2002/72; C01P 2004/03; C01P 2004/10; D10B 2101/02

(57) ABSTRACT

A material, comprising: a coherent structure comprising a plurality of entangled titania filaments having a lepidocrocite crystal structure. A method, comprising: with a suspension comprising (1) a plurality of titania filaments having a lepidocrocite crystal structure and (2) a solvent, effecting at least partial removal of the solvent so as to give rise to a material according to the present disclosure. A composition, comprising: a plurality of titania filaments having a lepidocrocite crystal structure; and a solvent, the plurality of titania filaments being suspended in the solvent.

### CROSS-REFERENCE TO RELATED APPLICATIONS

The present application claims priority to and the benefit of U.S. patent application No. 63/487,319, “Hydroxide Derived 1D Nanomaterial-Based Fiber Networks” (filed Feb. 28, 2023). All foregoing applications are incorporated herein by reference in their entireties for any and all purposes.

### TECHNICAL FIELD

The present disclosure relates to the field of nanomaterial fibers.

### BACKGROUND

There presently exists no method of assembling 1-D lepidocrocite-based titania nanofilaments into micron-sized porous fiber networks or gels. These materials present an opportunity to deliver the power of nanoscale materials and 1D lepidocrocite-based titania to new avenues of research and importantly applications. Accordingly, there is a long-felt need in the field for such methods and such materials.

### SUMMARY

In meeting the described long-felt needs, the present disclosure provides a material, comprising: a coherent structure comprising a plurality of entangled titania filaments having a lepidocrocite crystal structure.

Also provided are methods, comprising: with a suspension comprising (1) a plurality of titania filaments having a lepidocrocite crystal structure and (2) a solvent, effecting at least partial removal of the solvent so as to give rise to a material according to the present disclosure, e.g., according to any one of Aspects 1-6.

Further disclosed is a composition, comprising: a plurality of titania filaments having a lepidocrocite crystal structure; and a solvent, the plurality of titania filaments being suspended in the solvent.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various aspects discussed in the present document. In the drawings:

FIG. 1. Fiber-based network formation when a 35 mg/mL colloid of TiB₂ HDN is added to approximately 20 mL of isopropanol and shaken. (a) Formation of fibers is noticeable upon shaking in a vial and (b) spreads out significantly when poured into a petri dish. SEM micrographs (c) and (d) reveal seemingly porous fiber network that are confirmed by XRD (e) to be 1D lepidocrocite based.

FIG. 2 provides an exemplary illustration of the disclosed technology.

FIG. 3 provides an exemplary illustration of the disclosed technology.

FIG. 4 provides an exemplary illustration of the disclosed technology.

FIG. 5 provides an exemplary illustration of the disclosed technology.

FIG. 6 provides an exemplary illustration of the disclosed technology.

FIG. 7 provides an exemplary illustration of the disclosed technology.

FIG. 8 provides an exemplary illustration of the disclosed technology.

FIG. 9 provides an exemplary illustration of the disclosed technology.

### DETAILED DESCRIPTION OF ILLUSTRATIVE EMBODIMENTS

The present disclosure may be understood more readily by reference to the following detailed description of desired embodiments and the examples included therein.

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing. All publications, patent applications, patents and other references mentioned herein are incorporated by reference in their entirety. The materials, methods, and examples disclosed herein are illustrative only and not intended to be limiting.

The singular forms “a,” “an,” and “the” include plural referents unless the context clearly dictates otherwise.

As used in the specification and in the claims, the term “comprising” can include the embodiments “consisting of” and “consisting essentially of.” The terms “comprise(s),” “include(s),” “having,” “has,” “can,” “contain(s),” and variants thereof, as used herein, are intended to be open-ended transitional phrases, terms, or words that require the presence of the named ingredients/steps and permit the presence of other ingredients/steps. However, such description should be construed as also describing compositions or processes as “consisting of” and “consisting essentially of” the enumerated ingredients/steps, which allows the presence of only the named ingredients/steps, along with any impurities that might result therefrom, and excludes other ingredients/steps.

As used herein, the terms “about” and “at or about” mean that the amount or value in question can be the value designated some other value approximately or about the same. It is generally understood, as used herein, that it is the nominal value indicated ±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

Unless indicated to the contrary, the numerical values should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently of the endpoints. The endpoints of the ranges and any values disclosed herein are not limited to the precise range or value; they are sufficiently imprecise to include values approximating these ranges and/or values.

As used herein, approximating language can be applied to modify any quantitative representation that can vary without resulting in a change in the basic function to which it is related. Accordingly, a value modified by a term or terms, such as “about” and “substantially,” may not be limited to the precise value specified, in some cases. In at least some instances, the approximating language can correspond to the precision of an instrument for measuring the value. The modifier “about” should also be considered as disclosing the range defined by the absolute values of the two endpoints. For example, the expression “from about 2 to about 4” also discloses the range “from 2 to 4.” The term “about” can refer to plus or minus 10% of the indicated number. For example, “about 10%” can indicate a range of 9% to 11%, and “about 1” can mean from 0.9-1.1. Other meanings of “about” can be apparent from the context, such as rounding off, so, for example “about 1” can also mean from 0.5 to 1.4. Further, the term “comprising” should be understood as having its open-ended meaning of “including,” but the term also includes the closed meaning of the term “consisting.” For example, a composition that comprises components A and B can be a composition that includes A, B, and other components, but can also be a composition made of A and B only. Any documents cited herein are incorporated by reference in their entireties for any and all purposes.

### EXEMPLARY DISCLOSURE

After generating a colloidal suspension of 1-D lepidocrocite-based titania nanofilaments, NFs, the suspension was exposed to various solvents. The resulting exposure forced self-assembly of the suspended NFs into micron-sized filaments arranged in a highly porous network. Depending on the type of mixture, the microfilament constituents can change in size, shape, and overall properties; the materials produced here are arranged in such a way that they produce individual porous filaments, gels, and fabric-like material. Figures shown below. The following are a number of examples.

### EXAMPLE 1

### TiB₂ HDN in Isopropanol

TiB₂ HDN was synthesized and suspended in water as a colloid; example HDN synthesis approaches are set forth in, for example, PCT/US2022/070644 and PCT/US2023/072374, which foregoing references are incorporated herein by their entireties for any and all purposes.

As an example, one can contact ternary titanium carbides, nitrides, borides, phosphides, and silicides into HDN materials by immersing them in a tetramethylammonium hydroxide (TMAH) solution at temperatures in, e.g., the 25 to 85° C. range. One can also contact a mono-, binary, ternary, or higher carbide, nitride, boride, phosphide, aluminide, or silicide, or titanium metal with a quaternary ammonium salt and/or base, the mono-, binary, ternary, or higher carbide, nitride, boride, phosphide, aluminide, or silicide, or titanium metal optionally being non-water-soluble, the non-water soluble binary, or ternary, or higher carbide, nitride, boride, phosphide, aluminide, or silicide optionally comprising a transition metal, the transition metal optionally comprising titanium, the contacting being performed under conditions sufficient to give rise to a nanofilamentous product (HDN).

One can contact a mono-, binary, ternary, or higher carbide, nitride, boride, phosphide, aluminide, or silicide, or titanium metal with a quaternary ammonium salt and/or base, the mono-, binary, ternary, or higher carbide, nitride, boride, phosphide, aluminide, or silicide, or titanium metal optionally being non-water-soluble, the non-water soluble binary, or ternary, or higher carbide, nitride, boride, phosphide, aluminide, or silicide optionally comprising a transition metal, the transition metal optionally comprising titanium, the contacting optionally performed while shaking, the contacting being followed by washing with at least one salt and performed under conditions sufficient to give rise to mesoporous particles.

One can also contact a mono-, binary, ternary, or higher carbide, nitride, boride, phosphide, aluminide, or silicide, or titanium metal with a quaternary ammonium salt and/or base, the mono-, binary, ternary, or higher carbide, nitride, boride, phosphide, aluminide, or silicide, or titanium metal optionally being non-water-soluble, the non-water soluble binary, or ternary, or higher carbide, nitride, boride, phosphide, aluminide, or silicide optionally comprising a transition metal, the transition metal optionally comprising titanium, the contacting performed while shaking and at a temperature of from about 50 to about 95° C., followed by washing with LiCl to give rise to mesoporous particles In an example, approximately 20 g of TiB₂ was added to 170 mL of tetramethylammonium hydroxide, TMAH, in a polyethylene bottle and reacted for 5 days in a lab shaker at 80° C. After completion of the reaction, the suspension was washed by overhead stirring apparatus with approximately 300 mL of ethanol three times until the pH was neutral as indicated by pH strips; in each wash, ethanol was poured off as supernatant and discarded.

At this point, the consistency of the pH neutral material in ethanol was reminiscent of “mud”. Some of the latter was added to ~40 mL of deionized, DI, water and shaken to form a colloid. This colloid was centrifuged, and any residual precursor was removed as a solid. In the case of the fabric-like material (isopropanol and butanol mixture), the “mud” colloid was not centrifuged and thus some of the precursor remains as is evidenced by the XRD.

Approximately 1 mL of resulting colloidal suspension (concentration determined to be 35 mg/mL) was added to approximately 20 mL of isopropanol and shaken, affording the formation of a fiber-like network which was suspended in the isopropanol. The network was a light-yellow color. The isopropanol/fiber network was poured into a petri dish and the isopropanol was evaporated under ambient conditions.

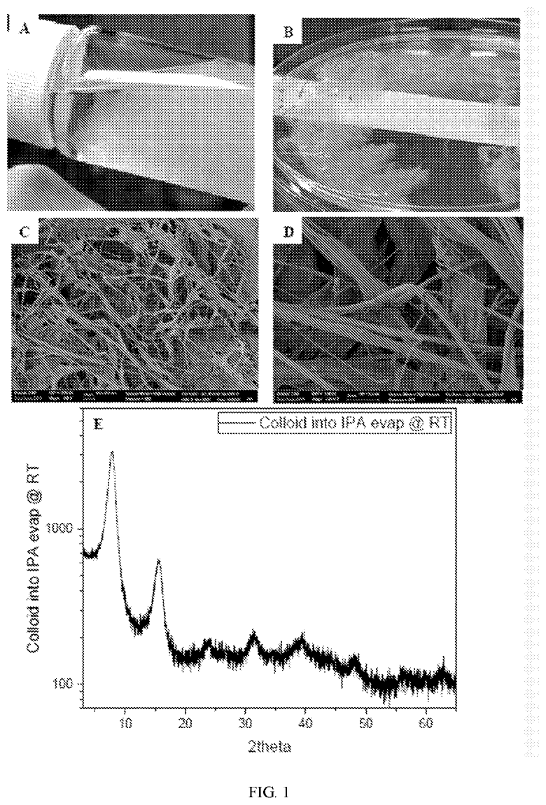

A piece of Celgard® filter paper membrane was necessary to prevent the fibers from sticking to the surface of the petri dish and instead afford a chip-like flake of fibers. The flakes were analyzed by XRD and SEM. The XRD pattern was acquired using a Rigaku SmartLab® equipped with a Cu Ka radiation source in the Bragg-Brentano geometry with a 10 mm incident slit. The samples were scanned from 3-65° 2Θ range with a step increment of 0.02° and a dwell time of 1.2 s/step. The SEM micrographs were acquired with the use of a ZEISS Supra 50 VP, Carl Zeiss SMT AG, Oberkochen, Germany). See FIG. 1.

Although the ratio of colloid to solvent in Example 1 above was 1:20, it should be understood that the ratio of colloid to solvent in the disclosed technology can be, for example, from 1:50 to 50:1, for example from 50:1 to 1:50, from 40:1 to 1:40, from 30:1 to 1:30, from 20:1 to 1:20, from 10:1 to 1:10, or even from 5:1 to 1:5.

### EXAMPLE 2

### TiB₂ HDN in Ethanol

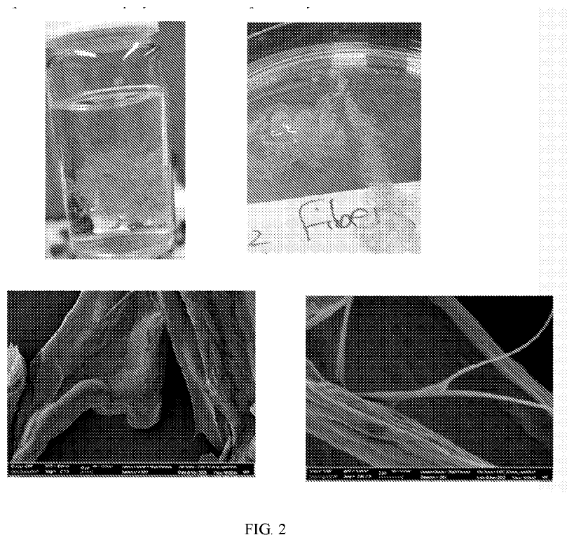

The same procedure was employed as is detailed previously in Example 1 but with ethanol. See FIG. 2.

### EXAMPLE 3

### TiB₂ HDN in Acetone

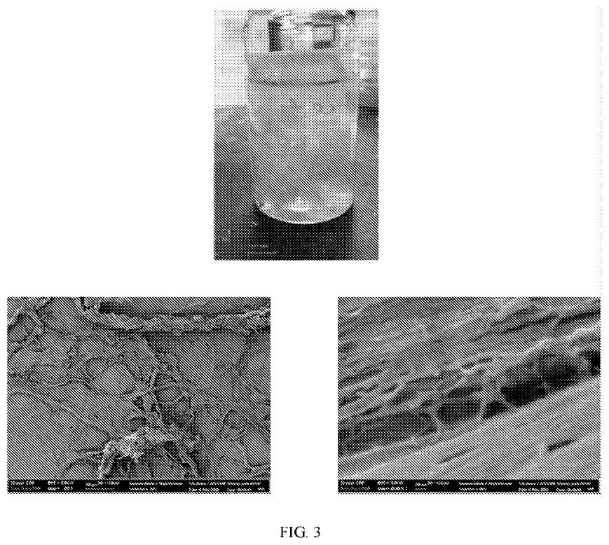

The same procedure was employed as is detailed in Example 1 but with acetone. See FIG. 3.

### EXAMPLE 4

### TiB₂ HDN in Acetonitrile

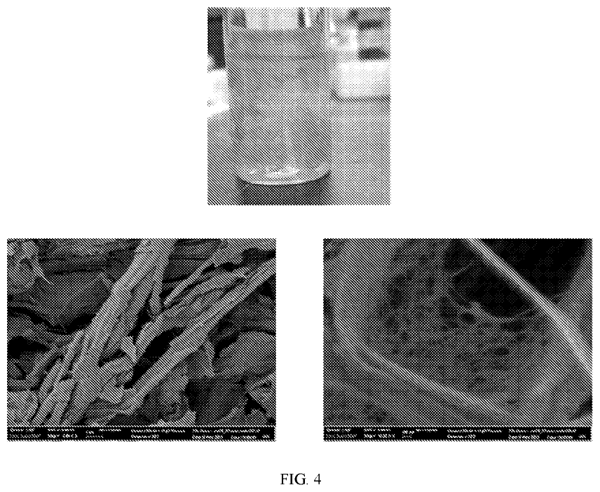

The same procedure was employed as is detailed in Example 1 but with acetonitrile. See FIG. 4.

### EXAMPLE 5

### TiB₂ HDN in Butanol

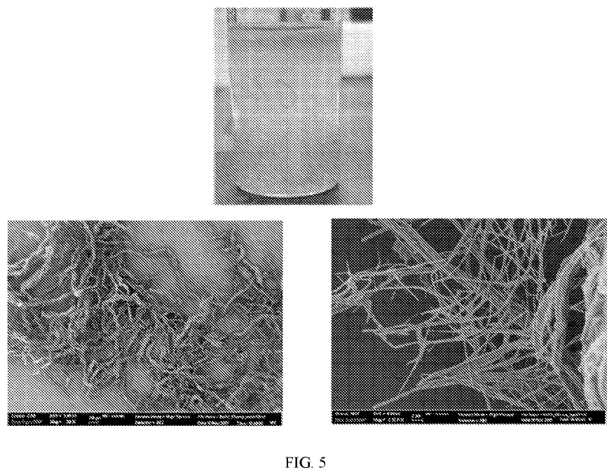

The same procedure was employed as is detailed in Example 1 but with butanol. See FIG. 5.

### EXAMPLE 6

### TiB₂ HDN in N,N-dimethylformamide

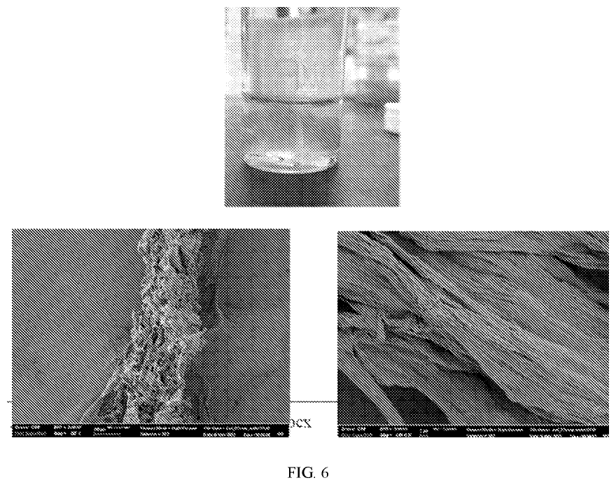

The same procedure was employed as is detailed in Example 1 but with N,N-dimethylformamide. See FIG. 6.

### EXAMPLE 7

### TiB₂ HDN in Methanol

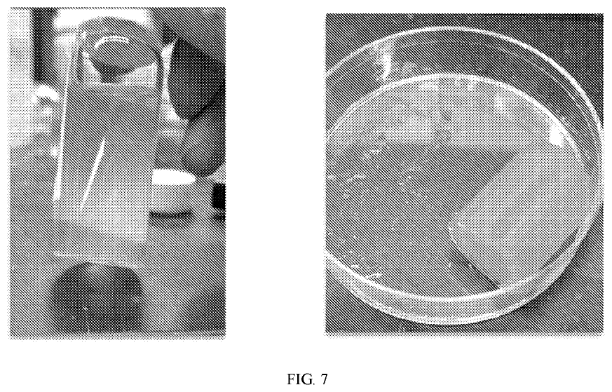

The same procedure was employed as detailed in Example 1 but with methanol. SEM images were not acquired since the fibers within the material seemed to crosslink into a yellow gel that could not be placed in a SEM chamber. See FIG. 7.

### EXAMPLE 8

### TiB₂ HDN in Isopropanol/butanol Solvent System

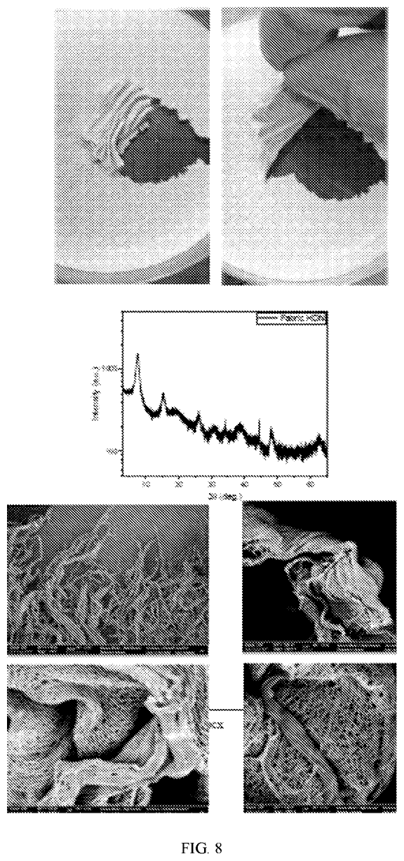

The TiB₂ HDN was generated as described in Example 1 above. Once the colloidal suspension was made, it was added to isopropanol. The resulting mixture produced the jelly-like fiber network of Example 1. However, once this formation began, an equal amount of butanol was added to the new suspension. The solution was poured into a petri dish and placed in a vacuum oven to drive off the solvent. Once the solvent evaporated, the remaining fibers assembled into a highly flexible fabric-like material. XRD confirms the 1D lepidocrocite-based titania is maintained, while SEM reveals web-like highly porous microfibers composed of interweaving nanofilaments. See FIG. 8.

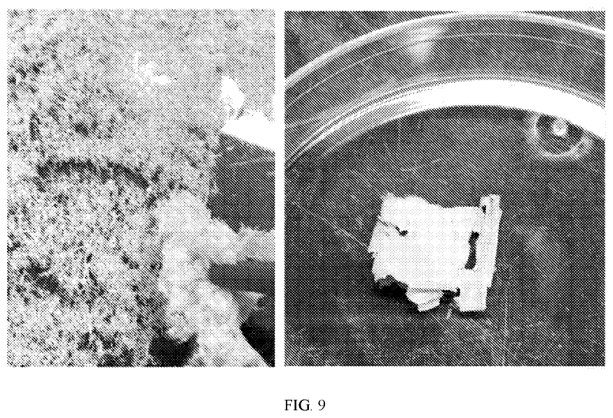

The ratio of IPA/butanol-in that particular embodiment-can be tailored and can result in different consistencies, such as the described wool-like material and paper-like material shown in FIG. 9. It should be understood that although a gel was formed using methanol-in Example 7 above-other solvents can be used to form gel-form materials. Thus, the disclosed technology can be used to form, without limitation, wool-like materials, paper-like materials, and even gels. The foregoing can be used in a variety of applications, including, without limitation, electrodes, filters, reactors, separators, and the like.

### Aspects

The following Aspects are illustrative only and do not limit the scope of the present disclosure or the appended claims. Any part or parts of any one or more Aspects can be combined with any part or parts of any one or more other Aspects.

Aspect 1. A material, comprising: a coherent structure comprising a plurality of entangled titania filaments having a lepidocrocite crystal structure.

Without being bound to any particular theory or embodiment, macroscopic fibers can be present. It was observed that when one added colloid to butanol, smaller filaments were obtained. In some embodiments, microfilaments were braided together to form a macrofilament; a microfilament can also be porous. A filament can have a thickness such as a diameter—in the range of from 1-10 nm, from 10-100 nm, from 100-1000 nm, or even from about 5000-10000 nm, in some embodiments. A filament can have a length of from about 1 to about 10 microns, from about 10-50 microns, or even from 50-100 microns. Example filaments and related fabrication methods are found in, for example, PCT/US2022/070644 and PCT/US2023/072374, both of which are incorporated herein by reference for any and all purposes.

Aspect 2. The material of Aspect 1, wherein the coherent structure is freestanding. Filaments can be braided or otherwise intertwined.

Aspect 3. The material of any one of Aspects 1-2, wherein the coherent structure is characterized as a fabric. The coherent structure can also be characterized as wool-like, in some embodiments. The coherent structure can be present in the form of a sheet or leaf; the coherent structure can also be present in the form of a puff, ball, skein, hank, or cake.

Aspect 4. The material of any one of Aspects 1-2, wherein the coherent structure is characterized as a gel.

Aspect 5. The material of any one of Aspects 1-4, wherein the coherent structure is substantially free of binders.

Aspect 6. The material of any one of Aspects 1-5, wherein the coherent structure is substantially free of solvents.

Aspect 7. A method, comprising: with a suspension comprising (1) a plurality of titania filaments having a lepidocrocite crystal structure and (2) a solvent, effecting at least partial removal of the solvent so as to give rise to a material according to any one of Aspects 1-6.

Aspect 8. The method of Aspect 7, wherein the at least partial removal of the solvent is effected by at least one of heat and reduced pressure.

Aspect 9. The method of Aspect 7, further comprising separating the a plurality of titania filaments from an aqueous suspension.

Aspect 10. The method of Aspect 9, further comprising contacting the separated plurality of titania filaments with the solvent to give rise to the suspension.

Aspect 11. The method of any one of Aspects 7-10, further comprising synthesizing the plurality of titania filaments.

Aspect 12. The method of any one of Aspects 7-11, wherein the solvent comprises any one or more of isopropanol, ethanol, acetone, acetonitrile, butanol, N, N-dimethylformamide, methanol, N-methyl-e-pyrrolidone (NMP), dimethyl sulfoxide (DMSO), tert-butyl alcohol (t-BuOH), and dimethyl methylphosphonate (DMMP).

Aspect 13. A composition, comprising: a plurality of titania filaments having a lepidocrocite crystal structure; and a solvent, the plurality of titania filaments being suspended in the solvent.

Aspect 14. The composition of Aspect 13, further comprising an amount of water.

Aspect 15. The composition of any one of Aspects 13-14, wherein the solvent comprises any one or more of isopropanol, ethanol, acetone, acetonitrile, butanol, N, N-dimethylformamide, methanol, N-methyl-e-pyrrolidone (NMP), dimethyl sulfoxide (DMSO), tert-butyl alcohol (t-BuOH), and dimethyl methylphosphonate (DMMP).

1. A material, comprising:
a coherent structure comprising a plurality of entangled titania filaments having a lepidocrocite crystal structure.

2. The material of claim 1, wherein the coherent structure is freestanding.

3. The material of claim 1, wherein the coherent structure is characterized as a fabric.

4. The material of claim 1, wherein the coherent structure is characterized as a gel.

5. The material of claim 1, wherein the coherent structure is substantially free of binders.

6. The material of claim 2, wherein the coherent structure is substantially free of solvents.

7. A method, comprising:
with a suspension comprising (1) a plurality of titania filaments having a lepidocrocite crystal structure and (2) a solvent,
effecting at least partial removal of the solvent so as to give rise to a material according to claim 1.

8. The method of claim 7, wherein the at least partial removal of the solvent is effected by at least one of heat and reduced pressure.

9. The method of claim 7, further comprising separating the a plurality of titania filaments from an aqueous suspension.

10. The method of claim 9, further comprising contacting the separated plurality of titania filaments with the solvent to give rise to the suspension.

11. The method of claim 7, further comprising synthesizing the plurality of titania filaments.

12. The method of claim 7, wherein the solvent comprises any one or more of isopropanol, ethanol, acetone, acetonitrile, butanol, N,N-dimethylformamide, and methanol.

13. A composition, comprising:
a plurality of titania filaments having a lepidocrocite crystal structure; and
a solvent,
the plurality of titania filaments being suspended in the solvent.

14. The composition of claim 13, further comprising an amount of water.

15. The composition of claim 13, wherein the solvent comprises any one or more of isopropanol, ethanol, acetone, acetonitrile, butanol, N,N-dimethylformamide, methanol, N-methyl-e-pyrrolidone (NMP), dimethyl sulfoxide (DMSO), tert-butyl alcohol (t-BuOH), and dimethyl methylphosphonate (DMMP).
